(19) United States
(12) Patent Application Publication
(10) Pub. No.: US 2015/0371266 A1
(43) Pub. Date: Dec. 24, 2015

(54) SYSTEM AND METHOD FOR DELIVERING CERTAIN WORK POSTED ON A SOCIAL NETWORK TO A TARGETED AUDIENCE

(71) Applicant: Shocase, Inc ., San Francisco, CA (US)

(72) Inventors: Ronald P. Young, Mill Valley, CA (US); David Anthony Burgess, Menlo Park, CA (US); Peter Rugg, New York, NY (US); Brad Nemer, San Francisco, CA (US)

(21) Appl. No.: 14/744,404

(22) Filed: Jun. 19, 2015

Related U.S. Application Data
(60) Provisional application No. 62/014,131, filed on Jun. 19, 2014.

(51) Int. Cl. G06Q 30/02; G06F 17/30; G06Q 50/00; H04L 29/08

(52) U.S. Cl. CPC G06Q 30/0257; H04L 67/10; H04L 67/02; G06F 17/30882; G06Q 50/01; G06Q 30/0277

(57) ABSTRACT

Methods, systems, and media are directed to outbound messaging for a social networking site. A server stores profile information and project information of users of the social networking site and a targeted outbound messaging template. The targeted outbound messaging template includes a recipient section that lists intended recipients of a message, a messaging text section that accommodates entry of text, a hyperlinked source section containing hyperlinked preview images of user projects to be included and displayed in the message, and a ranked collaborators section that identifies and ranks collaborative relationships associated with a sender and the recipients of the message. Upon activation of the targeted outbound messaging template, the server operates to automatically display the recipient section, the messaging text section, and the hyperlinked preview images of projects for sender selection, and upon transmission of the message, the server operates to automatically include the ranked collaborators section in the message.

### CROSS-REFERENCE TO RELATED APPLICATIONS

This Application claims priority to U.S. Provisional Patent Appln. Ser. No. 62/014,131, filed Jun. 19, 2014 entitled, “System and Method For Delivering Certain Work Posted on a Social Network to a Targeted Audience.”

This Application is also related to U.S. application Ser. No. 14/507,003, filed Oct. 6, 2014 entitled, “System and Method to Provide Collaboration Tagging for Verification and Viral Adoption,” which claims priority to U.S. Provisional Patent Appln. Ser. No. 61/887,423, filed Oct. 6, 2013 entitled, “A System and Method To Provide Collaboration Tagging for Viral Verification and Adoption.”

### FIELD OF THE INVENTION

The invention generally relates to aspects of networking site platforms and, more particularly to a targeted or marketing-focused messaging template construct to be used in conjunction with social networking site, portfolio site, and media sharing site platforms.

### BACKGROUND OF THE INVENTION

Given their immense popularity, social networking websites have spawned in prodigious numbers across the globe. The attraction of these websites rests squarely on their ability to enable users to socially interact with other users by facilitating the sharing of user-generated content, such as, blogs, images, videos, messages, etc.

In the beginning, social networking websites were more of a curious novelty, as they were utilized for fun, to show off, to report time, place or share other aspects of social behavior to entertain and converse with friends. In time, certain celebrities began to develop large followings of people, fans, who wanted the instant news on their favorite celebrities.

Eventually, astute business professionals began to see the power of the social network platform to enhance and communicate with a business network. Early business networks tended to be collections of people related through little more than an exchange of business cards. However, recent trends appear to demonstrate that Internet-based networks having business purposes are beginning to eclipse the social sphere. Such business purposes include outbound-marketing campaigns directed to general Internet-based solicitations to a broad range of recipients, such as, sending mass, “cold pitch” emails to potential customers. However, the efficacy of these cold pitch email campaigns remains dubious, at best.

### SUMMARY OF THE INVENTION

The invention, as disclosed herein, addresses the deficiencies and drawbacks noted above by providing systems and methods that are directed to a targeted or marketing-focused messaging template construct to be used in conjunction with Internet-accessible social network sites, portfolio sites, media sharing sites, etc. The messaging template construct provides a robust messaging facility that automatically composes, formats, and compresses correspondence along with providing a link to a landing page to expose message recipients to more information about the projects and/or media. In this manner, message senders may convey and display compressed images of work and materials with significantly reduced requirement for bandwidth than attached files, and can automatically add pictures and names of individuals who are personal and business associates of both the sender and the recipient, thus enhancing the value of the message to both parties.

The disclosed systems, computer-implemented methods, and media are directed to outbound messaging for a social networking site. A server stores profile information and project information of users of the social networking site and a targeted outbound messaging template. The targeted outbound messaging template includes a recipient section that lists intended recipients of a message, a messaging text section that accommodates entry of text, a hyperlinked source section containing hyperlinked preview images of user projects to be included and displayed in the message, and a ranked collaborators section that identifies and ranks collaborative relationships associated with a sender and the recipients of the message. Upon activation of the targeted outbound messaging template, the server operates to automatically display the recipient section, the messaging text section, and the hyperlinked preview images of projects for sender selection, and upon transmission of the message, the server operates to automatically include the ranked collaborators section in the message.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 depicts a general overview of an Internet-accessible social networking site, in accordance with various aspects of the present disclosure.

FIG. 2 depicts a marketing-focused outbound messaging template construct to be used in conjunction with Internet-accessible social network sites, portfolio sites, media sharing sites, etc., in accordance with various embodiments of the present disclosure.

FIG. 3 depicts a functional flow chart detailing the process of composing and sending a message in the form of an email employing the marketing-focused outbound messaging template, in accordance with various aspects of the present disclosure.

FIG. 4 depicts a layout of the marketing-focused email received by a recipient, in accordance with various aspects of the present disclosure.

FIG. 5 depicts a functional flow chart detailing the process of responding to message in the form of an email employing marketing-focused outbound messaging template from a social networking site, in accordance with various aspects of the present disclosure.

FIG. 6 depicts a number of projects and the connections between those people and who has collaborated on which project, in accordance with various aspects of the present disclosure.

### DETAILED DESCRIPTION OF THE INVENTION

In the following description, for the purposes of explanation, numerous specific details are set forth in order to provide a thorough understanding of the implementations of the invention. It will be appreciated, however, by those having skill in the art that the implementations of the invention may be practiced without these specific details or with an equivalent arrangement. In other instances, well-known structures and devices are shown in block diagram form in order to avoid unnecessarily obscuring the implementations of the invention.

As will be apparent by the ensuing description and illustrations, the disclosed embodiments relate to a marketing-focused messaging template construct to be used in conjunction with social networks or media sharing sites. The messaging template construct provides a robust messaging facility that automatically composes, formats, and compresses correspondence along with providing a link to a landing page to expose message recipients to more information about the projects and/or media.

In particular, the marketing-focused messaging template construct is configured to have an address bar for one or more recipients, a message area for text composed by the sender, and an area for selecting images representative of one or more pieces of collateral work product the sender desires to promote or market.

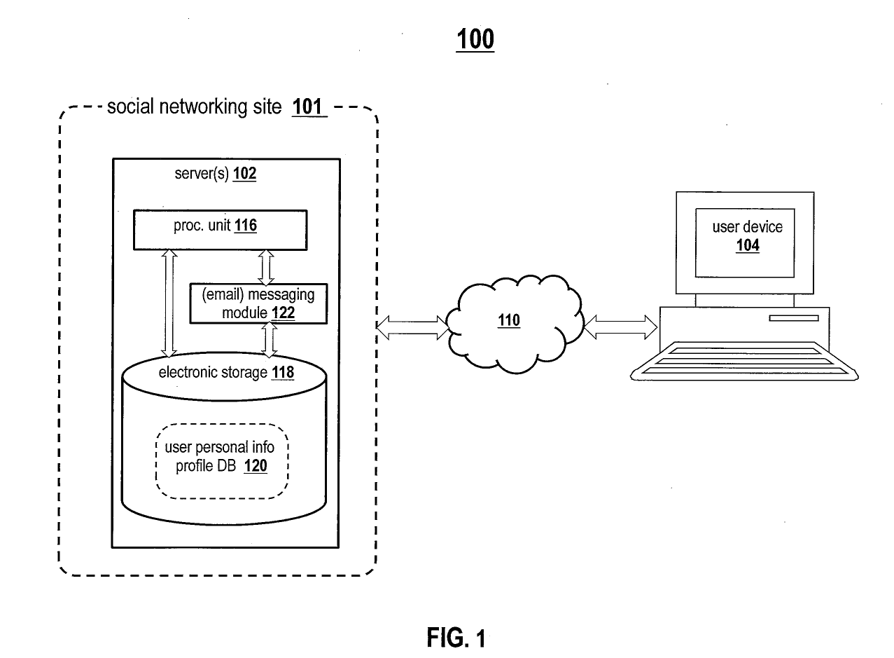

By way of illustration, FIG. 1 depicts a general overview of an Internet-accessible social network site system 100, in accordance with various aspects of the present disclosure. The platform of system 100 includes social networking website 101 that is hosted by server (or servers) 102, which are configured to communicate with, and process information from, remotely-situated user communication device(s) 104 via a communication facility, such as, for example, the Internet 110. While user communication device(s) 104 is illustrated as a desktop computer, it will be appreciated that user communication device 104 may comprise any number of communication-enabled devices, such as, for example, a laptop, mobile device, cellular/smartphone, gaming device, tablet computer, personal communication system (PCS) device, personal digital assistant (PDA), and/or any other electronic wireless-enabled device configured to transmit and receive communications via wired or wireless networks.

Server(s) 102 of social network site system 100 may embody one or more computing devices incorporating hardware components, operating systems, and programming languages that may be familiar to those skilled in the art in order to implement the processing as described herein. The computing devices may include one or more memory storage devices, such as, electronic storage device(s) 118 as well as one or more physical processing units 116 programmed with one or more computer program instructions to perform the functionality of social networking website 101, in addition to other components. As such, processing unit(s) 116 may embody one or more of a digital processor, analog processor, digital circuit designed to process information, analog circuit designed to process information, a state machine, and/or other mechanisms for electronically processing information. In some implementations, processing unit(s) 116 may include a plurality of processors that are physically located within the same computing device or may represent processing functionality of a plurality of devices operating in coordination.

As noted above, server(s) 102 may include memory storage devices, such as, electronic storage device(s) 118, which may store software algorithms, information generated by processing units 116, information received from other server(s) 102, information received from other computing platforms, or other information that enables the server(s) 102 to function as described herein. In particular, with regard to server(s) 102 of social networking website 101, electronic storage device(s) 118 may be configured to store information related to users in database(s) 120. Such user information may include personal information profile information containing username, user name/aliases, passwords, user descriptions, user lists of contacts, and user collaborators/colleagues as well as user projects, user professional accomplishments, user photographs, user businesses/projects/activities, user skills/experience, user personal achievements and awards, user exhibits, etc. The database(s) 120 may include, or interface with, for example, an Oracle™ relational database, Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed.

The computing devices may also include communication module(s) designed to establish the communication and accommodate the exchange of information between social networking website 101 and user device(s) 104 and amongst the users themselves via the communication facility, such as, the Internet 110. For example, such communication module(s) may include messaging systems module 122 that operates in conjunction with user database(s) 120 to create, process, transmit, receive, and direct messages to facilitate communication capabilities between users. Such messaging capabilities may take the form of emails, texting, instant messaging, social network messaging, etc.

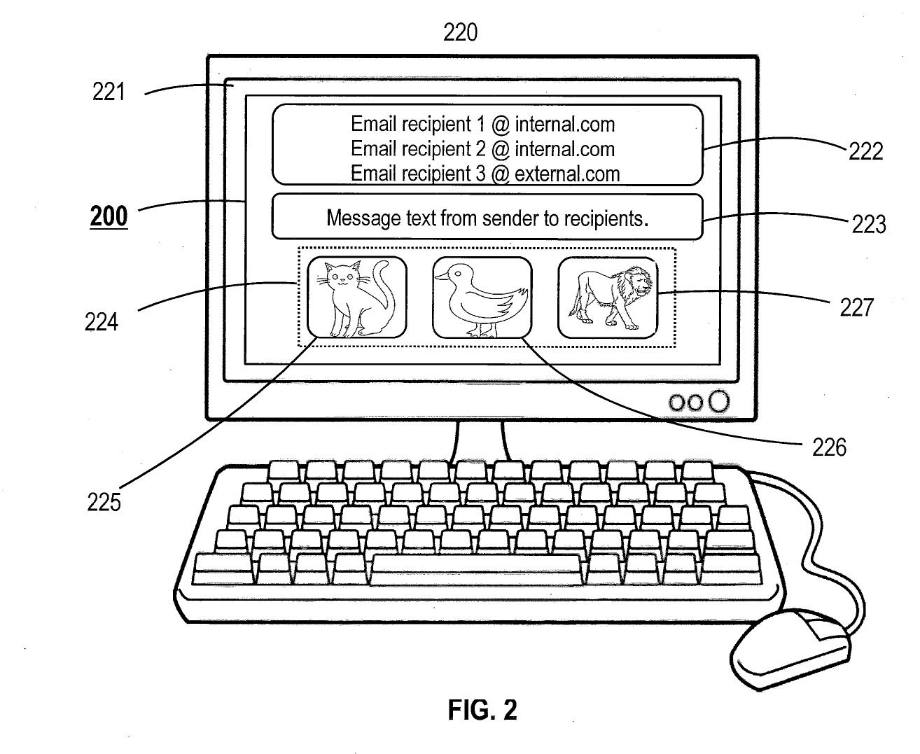

With this said, FIG. 2 depicts a marketing-focused outbound messaging template construct 200 to be used in conjunction with Internet-accessible social network sites, portfolio sites, media sharing sites, etc., in accordance with various embodiments of the instant disclosure. While messaging template 200 is shown in the form of an email messaging template having a certain layout and look, it will be appreciated that the messaging is not limited to emails nor is the depicted email template layout and look limiting in any way, as other messaging techniques (e.g., texting, instant messaging, social network messaging, etc.) and alternative looks are contemplated, as encompassed by the spirit of the overall invention.

Marketing-focused outbound messaging template construct 200 is associated with email messaging systems module 122 of system 100 to provide email messaging capabilities between users of social network site system 100. Email messaging template 200 is preferably constructed in HTML code so that it can be supported (i.e., displayed) by any email client platform. Messaging template construct 200 is stored on server(s) 102 and rendered in a messaging composition user interface (UI). This enables the user-sender to select their media assets (by default) or could select any media asset on system 100 to embed in the message. The location and formatting of each piece of information (e.g., name, company, recipient, and primary and secondary portfolio pieces) is managed by messaging template construct 200 to ensure uniform quality while maintaining flexibility in the number of projects shared in each message. Moreover, the use of server-based media assets and recipient contact informatibn allows the use of this feature on mobile devices—an important capability since the mobile devices of many professionals do not contain such assets on a regular basis.

It should be appreciated that users of conventional email applications must manually format each message each time. Not all users are professional designers, so visual impact will suffer. In fact, with conventional email applications, there are no economies of scale that can be leveraged across multiple email messages, no credibility-lending visual consistency, and no single-click connection to the disclosed functionality that demonstrates professional integrity based on team affiliation.

Returning to FIG. 2, marketing-focused outbound messaging template construct 200 may be displayed on screen 221 of user communication device 220 and is configured to present several component areas to a user of social network site system 100 that desires to send an email (i.e., user-sender). In particular, messaging template 200 comprises recipient area or section 222 configured to identify intended recipients of the message, as selected by the user-sender of social network site system 100. Recipient area 222 may list one or more email addresses of the intended recipients or their aliases and the intended recipients may be members of social network site system 100 or non-members. There may or may not be limits in place on the number of recipients who may be selected. Such limits may be part of social network site system 100, as there can be required payments for greater numbers of recipients or greater numbers of email messages.

Marketing-focused outbound messaging template construct 200 further comprises messaging area or section 223 to accommodate the entry of the message text authored by the user-sender and to be read by the intended recipients. In addition, messaging template 200 further comprises customized hyperlinked portfolio source area or section 224 that is configured to allow user-sender to select and embed a variety of individual project preview images 225, 226, 227 to be transmitted along with the email message and made available for review by the intended recipients. In one embodiment, the project previews 225, 226, 227 are presented to the user-sender either by automatically by default or by selection, enabling the user-sender to choose which project preview he desires to be included and the order in which they are displayed in the message.

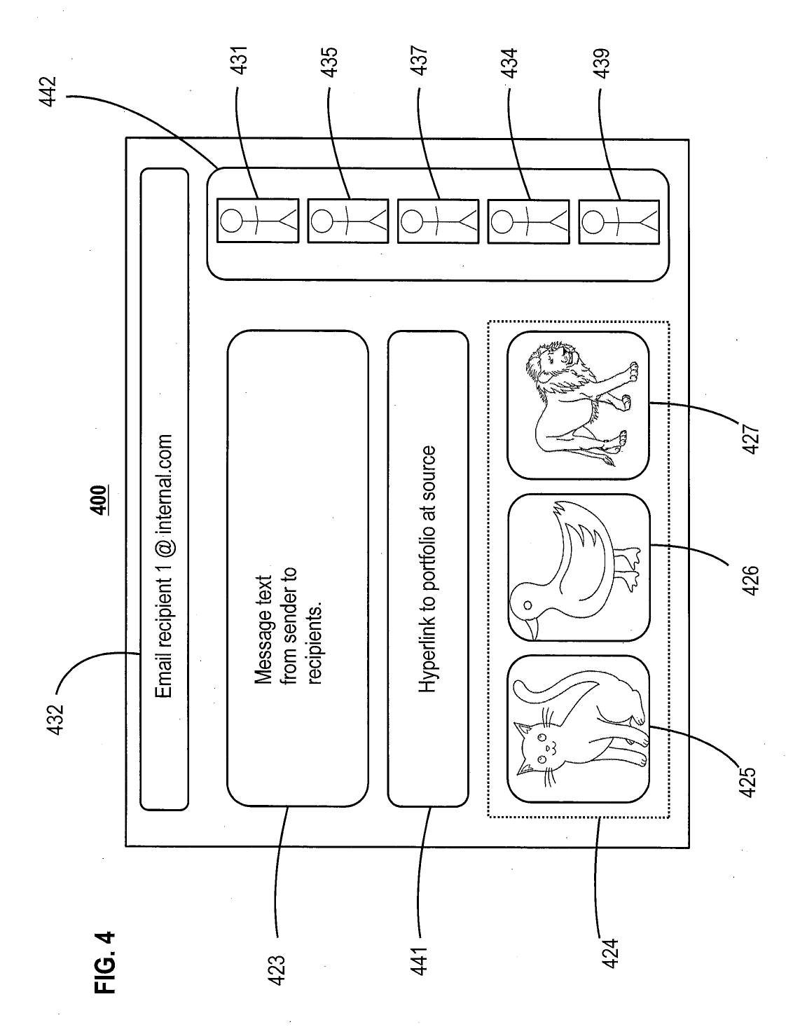

The customized hyperlinked portfolio area 224 is embedded with a hypertext/hyperlink code set that includes instructions to provide access to the entire portfolio or the individual attached projects attached 225, 226, 227. Each preview image is compressed to reduce bandwidth requirements and is configured to illustrate/depict part of the project that it represents. The preview image also contains a hyperlink that when activated by clicking on it, presents a special landing page on the social network site. As described in greater detail relative to FIG. 4 below, landing page shows the portfolio or project together with a set of hyperlinked images of people that could be connected to both the sender and the recipient through the project work or related experience or related contacts. The presentation of the personal associate list is accomplished by searching on the social network site all lists of collaborators who worked with the sender and the recipient and presenting matches of collaborators who worked with both. Activation of the hyperlink on the image of any personal associate renders the social network page for that person with listings of their projects and related collaborators.

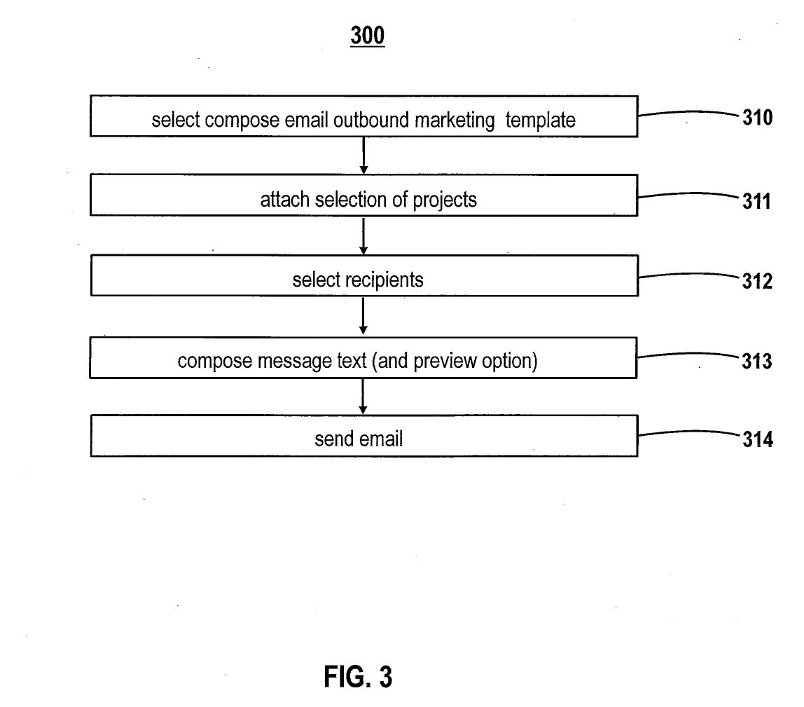

FIG. 3 depicts a functional flow chart of process 300, detailing the process of composing and sending an email that employs outbound marketing-focused email template 200 in conjunction with social network site 100; in accordance with various aspects of the present disclosure. Process 300 is executed by processing unit(s) 116 in association with email systems module 122 and user database(s) 120 of social network site system 100 to provide the user-sender of system 100 with a facility to create and send an outbound marketing-focused email to members and non-members of system 100. It will be appreciated that the sequence of tasks depicted in FIG. 3 is not intended to be limiting.

As shown at task 310 of FIG. 3, user-sender selects the compose email function presented by social network site 100. Upon selecting the compose email operation, the user-sender is provided with the option of selecting outbound marketing-focused email messaging template 200. Upon selecting the outbound marketing-focused email template 200, processing unit(s) 116, email systems module 122, and user database(s) 120 of social network site system 100 operate to generate the marketing-focused email template 200 and displays template 200 on the user device screen.

With marketing-focused email template 200 displayed on the screen, at task 311, the user-sender may choose from a number of projects to attach in customized portfolio area 224 of template 200. These chosen projects can be to showcase the user-sender's success and/or expertise in a given subject area. In addition to being highlighted in the outbound email, in another embodiment of the system, the selected projects can be tagged as being the contents of a portfolio of work containing specific attributes.

At task 312, the user-sender selects recipients for the outbound marketing email that he believes may be interest or would benefit from the opportunity. These recipients, which would be listed in recipient area 222 of template 200, could be members of the same social network (e.g., social network site 100) or be non-members with external email addresses. Further, the selected recipients may or may not be known to the sender with or without an established relationship through social network site 100. In another embodiment of the invention, the user-sender may search for people who hold a certain position in certain enterprises, and the system will return suggested proposed recipients. It is possible for a social network operator to curate people who hold positions of influence within the areas of endeavor germane to the social network together with their email address, title or position, and other people with whom the relevant person works or is associated. Such a curated database of people of influence provides a unique additional resource for the sender to select appropriate recipients.

At task 313, the user-sender enters the message text in messaging area 223 of template 200 to convey a personal message. Optionally, at this stage, the user-sender may be presented with the option of previewing the entire email with all of its constituent components. Then, at task 314, user-sender sends the outbound marketing email to the intended recipients. In this manner, members of a social network site are provided with a marketing-focused email template construct that is specifically designed to convey their portfolio of projects, skills, and experience to potential clients or colleagues. Based on this template, social network site members will be able to effectively communicate with other members or non-members, as potential clients, to promote their offerings in a streamlined, focused, manner without having to resort to directionless “cold pitch” mass emails.

FIG. 4 depicts a layout of the marketing-focused email 400 that is received and presented upon access by one of the recipients, in accordance with various aspects of the present disclosure. As shown, the received marketing-focused email 400 comprises several component areas, including recipient area 432, which identifies the recipient, and received message text area 423, which includes the message authored by user-sender and the portfolio selection area 424, which lists the three individual projects 425, 426, 427 selected by the user-sender.

The received marketing-focused email 400 further comprises hyperlink portfolio source area 441, which redirects the recipient to the portfolio upon the hyperlink being actuated, as well as portfolio preview area 424, which lists the three individual projects 425, 426, 427 submitted for review by the user-sender. This enables recipients to view the projects and work in full detail. With this option, activating the link on any project or any person will redirect the recipient back to the dedicated landing page for the recipient of this message from this sender.

The received marketing-focused email 400 also comprises ranked collaborators area 442. As will be described below, social network site system 100 is configured with the facility to automatically search for common collaborator and shared collaborator relationships between the user-sender and the recipient in order to enhance the appeal of the inbound message to the recipient. The collaborators are listed in order of connection relevance, according to a selected set of preset rules. In the depicted embodiment, a representation of user-sender 431 is displayed at the top of area 442, followed by the shared collaborators 435, 437, then the common collaborator 434, and finally an associate 439 who may have been associated with some of the projects.

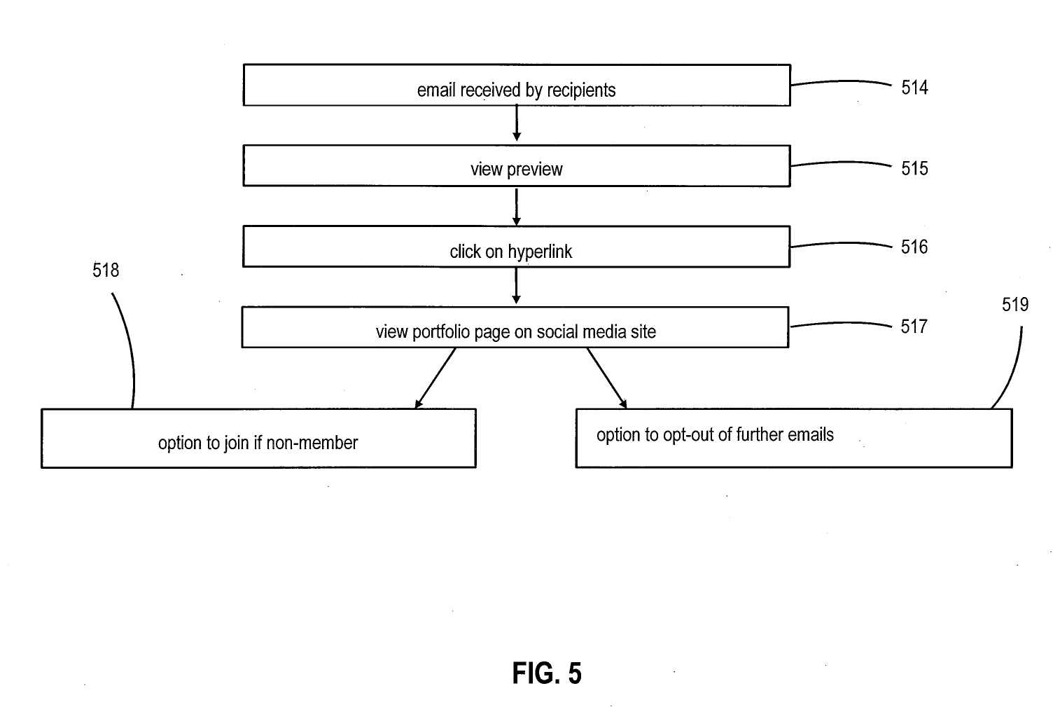

FIG. 5 depicts a functional flow chart detailing the process of responding to an email employing marketing-focused outbound email template from a social networking site, in accordance with various aspects of the present disclosure. As shown at task 514, received marketing-focused email 400 is presented to one of the intended recipients. It will be appreciated that privacy selections by recipients may determine whether the email message is received in an external email system, inside the social network system, or not at all if a blocking system is deployed.

At task 515, the recipients can view received marketing-focused email 400 and its constituent components, such as, the message text from the user-sender 423, previews of the projects in the portfolio being marketed 425, 426, 427, a hyperlink to the portfolio source web-page 441 in the social network and a list of collaborators 442 ranked and highlighted according to their connections to the recipient. The list of collaborators on the projects are ranked in order of connection to the recipient as determined by algorithms embedded in the system. The display of people who know and have worked with the user-sender, and also know and have worked with the recipient uniquely gives the recipient an important reason to view the material and thoughtfully consider the benefits of the proposal.

At task 516, the recipient can then choose to click on the hyperlink 441 and be redirected to the public page on the social network site that contains the projects or the entire portfolio that the sender attached. At task 517, the recipient may view projects or the entire portfolio. Basic user information will be on this page and a link to the user profile of the sender where, if the recipient is not a member of the social network site, at task 518, the system will prompt the recipient to join the site. Finally, at task 519, the recipient is provided with an option to opt-out of receiving any further emails from this particular user-sender.

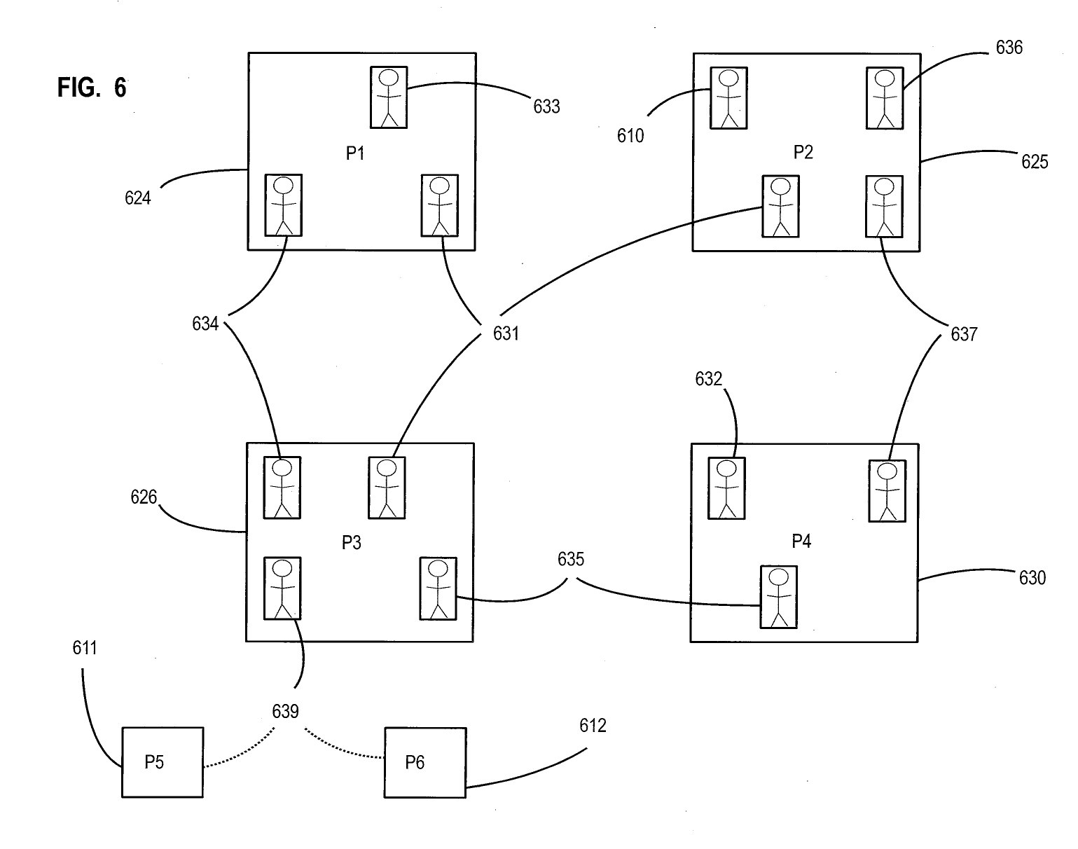

By way of illustration, FIG. 6 depicts a number of projects and the connections between those people and who has collaborated on which project, in accordance with various aspects of the present disclosure. As shown, four projects each have a number of collaborators associated with them. Three of the projects P1 624, P2 625 and P3 626 are those that may be selected by the user-sender 631. The user-sender 631 is connected to all three projects as shown. One of the recipients of the marketing email 632 is a collaborator of a fourth project P4 630. As can be seen amongst the many collaborators in the four projects there are some of those who are connected with more than one project. One member 635 collaborates in projects P3 626 and P4 630 and is a first degree collaborator, known as a shared collaborator, being common to the sender 631 and the recipient 632. Another first degree collaborator 637 participates in projects P2 625 and P4 630. Collaborators who have worked on more than one project with the sender are known as common collaborators and one such is 634.

Another set of collaborators are those that have the most projects in their profile, in this case 639 who has not only worked on P3 626 but also on a number of other projects including P5 611 and P6 612 as indicated by the dotted lines. Additionally there are collaborators who have only worked on single projects 633, 636, 610. Social network site system 100 includes processes and algorithms that automatically search for common collaborators and shared collaborators between the sender and the recipient and these relationships are utilized to enhance the appeal of the inbound marketing message to the recipient, thus making such targeted marketing more likely to be read and to generated a favorable result between the sender and the recipient.

As noted above, the selection of collaborators could be performed manually by the user-sender or automatically by the social network site server that has the database of user information. In one embodiment, the algorithm operates by: (a) finding all members that connected to the sender and the receiver, in which such connections could be a combination of project collaborators, address book contacts, people being followed; and (b) ranking all the connected members by relevance, in which the relevance may be determine by the importance of the connection, in accordance with a predetermined graduated figure of merit or a weighting process. For example, in one embodiment, connection importance is determined by assigning weights to various connections that results in the following order of descending priority for: (i) mutual project collaborators; (ii) mutual company contacts; (iii) mutual contacts; (iv) mutual people being followed; and (v) combinations of the above, for example the send could have collaborated with one person that the receiver has in their contact list.

Thus, by virtue of the described systems and methods, the disclosed marketing-focused messaging template construct provides a robust messaging facility that automatically composes, formats, and compresses correspondence to expose message recipients to more information about projects in a social networking environment. The messaging template construct is engineered to convey recipient-specific content, which is more likely to pique the interest of the message recipients. Along these lines, the described systems and methods provide an opportunity for anyone utilizing the system with a portfolio of projects on a social network site with collaborators to reach out to new potential clients in a professional and courteous manner with specific and applicable content of interest to the message recipients.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. An outbound messaging system for a social networking site, comprising:
a server configured to store profile information and project information of users of the social networking site; and
a targeted outbound messaging template stored on the server, the targeted outbound messaging template including:
a recipient section that lists intended recipients of a message,
a messaging text section that accommodates entry of text,
a hyperlinked source section containing hyperlinked preview images of user projects to be included and displayed in the message, and
a ranked collaborators section that identifies and ranks collaborative relationships associated with a sender and the recipients of the message,
wherein, upon activation of the targeted outbound messaging template, the server operates to automatically display the recipient section, the messaging text section, and the hyperlinked preview images of projects for sender selection, and
wherein, upon transmission of the message to the recipients, the server operates to automatically include the ranked collaborators section in the message.

2. The outbound messaging system of claim 1, wherein the selected hyperlinked preview images of projects are compressed to reduce bandwidth requirements.

3. The outbound messaging system of claim 1, wherein the selected hyperlinked preview images of projects are each configured with a hyperlink that when activated, presents a special landing page on the social networking site.

4. The outbound messaging system of claim 1, further comprising an option to preview a layout of the entire message prior to transmission.

5. The outbound messaging system of claim 1, wherein the targeted outbound messaging template is constructed based on an Internet-based mark-up language code.

6. The outbound messaging system of claim 1, wherein the targeted outbound messaging template is configured for email messaging.

7. The outbound messaging system of claim 1, wherein the stored user profile information and stored user project information includes one or more of the following data: user lists of contacts, user collaborators, user colleagues, user projects, user professional accomplishments, user photographs, user businesses, user activities, user skills and experience, user personal achievements and awards, and user exhibits.

8. The outbound messaging system of claim 1, wherein the ranked collaborators section includes identifying representations of collaborators.

9. The outbound messaging system of claim 8, wherein the representations of collaborators are displayed in an order of priority.

10. The outbound messaging system of claim 1, wherein the server automatically searches for collaborative relationships associated with the sender and recipients, based on the stored user profile information, and automatically ranks the resulting collaborative relationships to establish an order of priority.

11. A computer-implemented method of outbound messaging for a social networking site, comprising:
storing profile information and project information of users of the social networking site on a server;
storing a targeted outbound messaging template on the server, the targeted outbound messaging template including:
a recipient section that lists intended recipients of a message,
a messaging text section that accommodates entry of text,
a hyperlinked source section containing hyperlinked preview images of projects to be included and displayed in the message, and
a ranked collaborators section that identifies and ranks collaborative relationships between a sender and the recipients of the message,
wherein, upon activating the targeted outbound messaging template, the server operates to automatically display the recipient section, the messaging text section, and the hyperlinked preview images of projects for sender selection, and
wherein, upon transmission of the message to the recipients, the server operates to automatically include the ranked collaborators section in the message.

12. The computer-implemented method of claim 11, further comprising compressing the selected hyperlinked preview images of projects to reduce bandwidth requirements.

13. The computer-implemented method of claim 11, further comprising configuring the selected hyperlinked preview images of projects with a hyperlink that when activated, presents a special landing page on the social networking site.

14. The computer-implemented method of claim 11, further comprising providing an option to preview a layout of the entire message prior to transmission.

15. The computer-implemented method of claim 11, further comprising constructing the targeted outbound messaging template based on an Internet-based mark-up language code.

16. The computer-implemented method of claim 11, further comprising configuring the targeted outbound messaging template for email messaging.

17. The computer-implemented method of claim 11, wherein the stored user profile information and stored user project information includes one or more of the following data: user lists of contacts, user collaborators, user colleagues, user projects, user professional accomplishments, user photographs, user businesses, user activities, user skills and experience, user personal achievements and awards, and user exhibits.

18. The computer-implemented method of claim 11, further comprising providing identifying representations of collaborators in the ranked collaborators section.

19. The computer-implemented method of claim 18, further comprising displaying the representations of collaborators in an order of priority.

20. The computer-implemented method of claim 11, further comprising the server automatically searching for collaborative relationships associated with the sender and recipients, based on the stored user profile information, and automatically ranking the resulting collaborative relationships to establish an order of priority.
